(19) United States
(12) Patent Application Publication
(10) Pub. No.: US 2015/0298017 A1
(43) Pub. Date: Oct. 22, 2015

(54) HAND-LAUNCHED, SOLAR-POWERED AIRCRAFT

(71) Applicant: Toy Labs, Inc., San Carlos, CA (US)

(72) Inventors: Timothy J. CURLEY, San Carlos, CA (US); Gordon Paul BRADLEY, Independence, KY (US)

(73) Assignee: TOY LABS, INC., San Carlos, CA (US)

(21) Appl. No.: 14/256,898

(22) Filed: Apr. 18, 2014

(51) Int. Cl. A63H 29/22; A63H 27/00

(52) U.S. Cl. CPC A63H 29/22; A63H 27/001; B64C 2203/00

(57) ABSTRACT

Embodiments of a hand-launched solar-powered aircraft are disclosed. In addition, embodiments of kits are disclosed for the construction of a hand-launched solar-powered aircraft. Further, embodiments of methods of making a hand-launched aircraft are disclosed. In some embodiments, the hand-launched aircraft is solar-powered. Still further, embodiments of an educational kit for a hand-launched, solar-powered aircraft are disclosed. In various embodiments, the educational kit comprises educational material on one or more science and technology learning topics, which educational material is relevant to and supplemented by the assembly and/or operation of the aircraft. The education material can relate to, for example, one or more of flying techniques, aeronautics, renewable energy, electronics, mechanical engineering, and/or climatology.

### FIELD

The present teachings relate to the field of unmanned aircraft, and more particularly to hand-launched, solar-powered aircraft.

### BACKGROUND

Unmanned, hand-launched aircraft have been popular for many years. Models vary in their manner of control and propulsion. Free flight aircraft fly without external control from the ground. Other models employ control systems, such as control lines or radio control. Glider aircraft do not have an attached powerplant. Powered models include an onboard powerplant, i.e., a mechanism powering propulsion of the aircraft through the air. Electric motors and internal combustion engines are common propulsion systems, but other types include rocket, small turbine, pulsejet, compressed gas, and tension-loaded (twisted) rubber band devices. There is also solar powered flight, which has seen some limited and/or specialized use (see, for example, U.S. Pat. No. 4,415,133; and, Noth, André, Walter Engel, and Roland Siegwart. “Design of an Ultra-Lightweight Autonomous Solar Airplane for Continuous Flight.” In Field and Service Robotics, edited by Peter Corke and Salah Sukkariah, 25:441-52. Springer Tracts in Advanced Robotics. Springer Berlin Heidelberg, 2006. http://dx.doi.org/10.1007/978-3-540-33453-8_{—}37; each incorporated herein by reference).

Particularly with powered model aircraft, it is common that they are assembled by end-users from pre-packaged kits. Typically, these kits are aimed at hobbyists with a moderate to high degree of skill. Entry level kits are typically designed to help one develop the knowledge and skills needed to move on to the assembly of more complex models. While an admirable hobby, it should be appreciated that model airplane kits also provide a unique opportunity for hands-on learning and/or experiential learning even for the novice who has little or no desire to advance to complex models. There is a need for hand-launched, solar-powered aircraft and hand-launch powered aircraft kits that are accessible to the novice, and which embody one or more key science and technology learning topics.

### SUMMARY OF VARIOUS EMBODIMENTS

An exemplary and non-limiting summary of various embodiments is set forth next.

The present teachings provide, among other things, embodiments of hand-launched solar-powered aircraft. In addition, the present teachings provide embodiments of kits for the construction of hand-launched solar-powered aircraft. Further, the present teachings provide embodiments of methods of making hand-launched aircraft. In some embodiments, the hand-launched aircraft are solar-powered. Still further, the present teachings provide embodiments of an educational kit for a hand-launched, solar-powered aircraft.

According to various embodiments, a hand-launched solar-powered aircraft in accordance with the present teachings can comprise, for example: an elongated airfoil or wing, including a main wing portion; a solar panel on an upper surface of the main wing portion; a fuselage comprising a slit for receiving and supporting the main wing portion; a vertical stabilizer and a horizontal stabilizer rearward of the fuselage; a motor-driven propeller at an end of the fuselage; one or more super-capacitors supported by the fuselage; means for electrically communicating the solar panel and the super-capacitors; circuitry connecting the super-capacitor with the motor-driven propeller; and, a switch in the circuitry accessible from outside the fuselage. In various embodiments, the aircraft further comprises means for preventing or avoiding propeller (prop) strikes.

In various embodiments, the hand-launched solar-powered aircraft further comprises one or more batteries and/or fuel cells (e.g., micro fuel cells) disposed for electrical communication with the super-capacitors. According to various embodiments, one or more batteries and/or fuel cells (e.g., micro fuel cells) are provided on the aircraft, in place of the super-capacitors.

In various embodiments, the means for electrically communicating the solar panel and the super-capacitor can comprise electrically conductive lines, e.g., electrical wiring. For example, in some embodiments, the means for electrically communicating the solar panel and the super-capacitor can comprise: first and second lead wires extending from the solar panel; first and second lead-wire connectors on the fuselage adapted to receive the first and second lead wires, respectively; and, first and second electrical lines electrically communicating the first and second lead-wire connectors with the super-capacitor.

According to various embodiments, the elongated wing further includes an add-on port wing tip portion and an add-on starboard wing tip portion; with the wing tip portions disposed at respective ends (port and starboard) of the main wing portion. In various embodiments, the aircraft further comprises a plurality of stickers, and the wing tip portions can be fastened to the main wing portion, at least in part, by way of the stickers.

According to various embodiments, the wingspan of the aircraft, from the port wing tip to the starboard wing tip, spans no more than about 42 inches, no more than about 36 inches, no more than about 24 inches, no more than about 18 inches, and in some embodiments, no more than about 12 inches.

According to various embodiments, the aircraft further comprises first and second booms, each comprising a slit towards its forward end for receiving a respective edge region of the main wing portion. In various embodiments, each of the booms further comprises a vertical stabilizer at its rearward end. According to various embodiments, the horizontal stabilizer bridges the vertical stabilizers. In various embodiments, the aircraft further comprises a plurality of stickers, and the horizontal stabilizer is fastened to the vertical stabilizers by way of the stickers.

According to various embodiments, the propeller comprises a pusher propeller mounted at the rear of the fuselage. In some embodiments, one or more pusher propellers are mounted on each of the wings. In various embodiments, a standard or tractor propeller can be mounted at the front of the fuselage.

In various embodiments, the aircraft further comprises one or more sensors on it adapted to collect flight-related information and/or environmental information. In some embodiments, the sensors comprise one or more of: a camera, a power meter, a volt meter, a timer, an altimeter, an airspeed micro-sensor, a GPS (global positioning system unit), a thermometer, a hygrometer, a barometer, a compass, an accelerometer, a gyroscope, a magnetometer, a luxmeter, a microphone, a proximity sensor, a bank sensor, and an attitude sensor. In various embodiments, a chronometer is provided. According to various embodiments, the flight-related information and/or environmental data for collection includes one or more of solar power generation data, power consumption data, voltage data, RPM data, signal strength data, flight time data, image capture data, temperature data, barometric altitude data, humidity data, light intensity data, air pressure data, wind data, bank data, attitude data, and time data; and GPS data including ground speed data, airspeed data, altitude data, latitude data, longitude data, rate of climb data, distance data, and directional (compass) data including heading data.

According to various embodiments, flight-related information that has been collected can be stored onboard for later retrieval. For example, the information can be written to a removable flash memory card (e.g., a MICRO SD (secure digital) card) that can be removed and read by a computing apparatus. In some embodiments, the aircraft is provided with an externally-accessible connector (e.g., a micro-USB connector) attached to an internal memory device, and an appropriate cable can be attached to the connector to off-load collected information (e.g., the cable can be connected at its other end to a computing apparatus, for example, via another USB connector). In various embodiments, the information can be retrieved wirelessly, e.g., by way of a radio transceiver, such as a Bluetooth radio, onboard the aircraft. According to various embodiments, the information can be retrieved wirelessly by way of a Wi-Fi module onboard the aircraft.

In various embodiments, flight-related information that has been collected can be off-loaded from the aircraft while the aircraft is in flight. According to various embodiments, flight-related information is off-loaded substantially in real time as it is collected. In various embodiments, flight-related information is off-loaded by way of a wireless radio transceiver onboard the aircraft. For example, in some embodiments, a Wi-Fi module is provided on the aircraft that can connect to a network to off-load flight-related information while the aircraft is in flight. In various embodiments, flight-related information off-loaded over a network can be placed in cloud storage, as desired.

According to various embodiments, one or more components of telemetry equipment are provided on the aircraft, including a telemetry transmitter.

According to various embodiments, the main wing portion includes an upper surface, a lower surface, and a plurality of slits extending from the upper surface to the lower surface and generally parallel to the wing chord or camber line. In various embodiments, the aircraft can further comprise a plurality of tabs dimensioned to fit snugly in the slits of the main wing portion, in a direction substantially normal to the upper and lower surfaces of the main wing portion; and, a plurality of stickers for securing the tabs to the fuselage and the booms.

Additional aspects of the present teachings relate to a kit for constructing a hand-launched solar-powered aircraft. In various embodiments, a kit according to the present teachings can comprise, for example: a main airfoil or wing portion, including an upper surface, a lower surface, and a plurality of slits extending from the upper surface to the lower surface and generally parallel to the wing chord or camber line; a solar panel for attachment to the upper surface of the main wing portion; a fuselage, including a slit for receiving and supporting the main wing portion; a plurality of tabs dimensioned to fit snugly in the slits of the main wing portion, in a direction substantially normal to the upper and lower surfaces of the main wing portion; a plurality of stickers for fastening components of the aircraft together; and, instructions for assembling and flying the aircraft. In some embodiments, the instructions are in hard-copy format, and in other embodiments, the instructions are available online and a pointer (e.g., a url or hyperlink) is provided to them.

According to various embodiments, the kit can further comprise first and second booms, each including a slit towards its forward end for receiving a respective edge portion of the main wing portion, and a vertical stabilizer at its rearward end. The kit can further comprise first and second wing tip portions for attachment to respective edge regions of the main wing portion to thereby comprise an elongated main wing. In various embodiments, the horizontal stabilizer is configured to bridge the vertical stabilizers.

In various embodiments, the kit further comprises at least one super-capacitor supported by the fuselage. In some embodiments, two or more super-capacitors are employed.

According to various embodiments, the kit can further comprise: first and second servos supported by the fuselage; a rudder hingedly connected to the vertical stabilizer by way of a sticker; an elevator hingedly connected to the horizontal stabilizer by way of a sticker; a first mechanical linkage operably connecting the first servo and the rudder such that the servo can cause the rudder to pivot side-to-side; and, a second mechanical linkage operably connecting the second servo and the elevator such that the servo can cause the elevator to pivot up and down. In some embodiments, one or both of the servos are programmable by a user.

In various embodiments, the kit further comprises programmable means for controlling the movement of the rudder and elevator. In a variety of embodiments, the programmable means for controlling the movement of the rudder and elevator comprise one or more programmable servos.

According to various embodiments, the kit further comprises remote-control means for controlling the movement of the servos. In a variety of embodiments, the remote-control means comprises a remote control receiver supported by the fuselage and adapted for communication with the servos.

In various embodiments, the kit further comprises a controller for controlling the aircraft. In some embodiments, the controller comprises a control line. The lines on a control line airplane serve multiple purposes. One purpose is to confine the flight path to a radius or hemisphere around the pilot. Another function is to control the movement of the control surfaces, e.g., the elevator. According to various embodiments, a control line system can employ two lines which are connected to opposite sides of a control handle. When the pilot rotates his wrist, one line is retracted while the other is extended. The lines can be connected to a bell-crank which in turn controls the elevator via a push rod. In various embodiments, a third or auxiliary line can be used to control the power plant, e.g., motor.

According to various embodiments, a control line is employed, however, it is connected to a stake, anchor, or other fixed object at the ground instead of being held by a pilot. The airplane can then revolve around such fixed object. According to various embodiments, solar panel arrays can be arranged on the airplane so that adequate sunlight on an appropriately sunny day is captured throughout the airplane's revolutions, allowing substantially continuous flight. Not only can such an airplane system provide education and entertainment, but it can act as a visual locator beacon, as well.

In a variety of embodiments, the controller comprises a radio controller. The controller can be, for example, battery powered and/or solar powered. The controller can also comprise a computer device (smartphone, tablet, laptop or desktop).

According to various embodiments, the kit can further include educational material, such as instructional material in one or more of the following fields: flying techniques, aeronautics, renewable energy, electronics, mechanical engineering, and climatology.

Further aspects of the present teachings related to methods of making a hand-launched aircraft. In various embodiments, the hand-launched aircraft can be solar-powered.

According to various embodiments, a method of making a hand-launched aircraft can comprise, for example: inserting an airfoil or main wing portion into a slit of a fuselage to the general midpoint of the main wing portion, such that the main wing portion rests snugly in the slit; inserting a tab into a slit extending through the main wing portion, substantially normal to the upper and lower surfaces of the main wing portion and adjacent the fuselage, so that at least a portion of the tab, held snugly in the slit, abuts the fuselage; and, applying a sticker across at least a portion of the tab and onto one or more portions of the fuselage, thereby fixing the spatial relationship between the main wing portion and the fuselage.

According to various embodiments, the method can further comprise applying a solar panel to the upper surface of the main wing portion.

According to various embodiments, the method further comprises electrically communicating the solar panel with one or more super-capacitors supported by the fuselage.

In various embodiments, the method further comprises attaching first and second booms to respective edge portions of the main wing portion by way of a slit in each of the booms configured to receive such an edge portion of the main wing portion. According to various embodiments, the method further comprises, for each boom, inserting a tab into a slit extending through the main wing portion, substantially normal to the upper and lower surfaces of the main wing portion and adjacent the boom, so that at least a portion of the tab, held snugly in the slit, abuts the boom; and, applying a sticker across at least a portion of the tab and onto one or more portions of the boom, thereby fixing the spatial relationship between the main wing portion and the boom.

In various embodiments, the method further comprises attaching first and second wing tip portions to respective edge regions of the main wing portion by way of stickers.

According to various embodiments, the method further comprises attaching a horizontal stabilizer to a pair of spaced-apart, generally parallel vertical stabilizers rearward of the fuselage, such that the horizontal stabilizer bridges the vertical stabilizers. In various embodiments, the attachment of the horizontal stabilizer to the vertical stabilizers is made by way of stickers.

Further aspects of the present teachings relate to an educational kit for a hand-launched, solar-powered aircraft, comprising: (i) a plurality of solar-powered aircraft component parts, comprising: (a) a wing; (b) a solar panel for attachment to the wing; (c) a fuselage for supporting the wing; (d) a vertical stabilizer and a horizontal stabilizer, optionally including a rudder and an elevator, respectively; (e) a motor-driven propeller, such as a pusher propeller; (f) one or more power-storage units, e.g., super-capacitors, supported by said fuselage; (g) a plurality of electrical lines, e.g., wires, for communicating said solar panel and said power-storage units; (h) circuitry for connecting said power-storage units with said motor-driven propeller; and, (i) a switch, e.g., a finger-operable switch, in said circuitry; (ii) instructions for assembling and operating said aircraft; and, (iii) educational material on one or more science and technology learning topics, which educational material is relevant to and supplemented by the assembly or operation of the aircraft.

In various embodiments, the educational material relates to flying techniques, aeronautics, renewable energy, electronics, and/or mechanical engineering. In some embodiments, the educational material relates to renewable energy, electronics, and/or mechanical engineering.

According to various embodiments, one or more of the solar-powered aircraft component parts are preassembled in the kit.

In various embodiments, the instructions are provided in hard copy format. In a variety of embodiments, the instructions are provided online, and a pointer (e.g., hyperlink or url) to the instructions is provided in the kit.

In various embodiments, the educational materials are provided in hard copy format. In a variety of embodiments, the educational materials are provided online, and a pointer (e.g., hyperlink or url) to the educational materials is provided in the kit.

According to various embodiments, the wingspan of the assembled, ready-to-fly aircraft of the kit spans no more than about 48 inches; no more than about 36 inches; no more than about 24 inches; no more than about 18 inches; no more than about 12 inches; and, in some embodiments, no more than about 8 inches.

### BRIEF DESCRIPTION OF THE DRAWINGS

Other systems, methods, features and advantages of the present teachings will be or will become further apparent to one with skill in the art upon examination of the following figures and description.

FIGS. 1-2 show perspective views, from the front and rear, respectively, of the upper side of a hand-launched, solar-powered aircraft, in accordance with various embodiments;

FIG. 3 shows a perspective view of the underside of the hand-launched, solar-powered aircraft of FIGS. 1-2, with portions partially exploded, in accordance with various embodiments;

FIG. 4 is a circuit diagram showing aspects of the electronics for a solar-powered aircraft, in accordance with various embodiments;

FIG. 5 is a perspective view of the rearward portion of an aircraft comprising servos with mechanical linkages for moving pivotal control surfaces, according to various embodiments;

FIG. 6 is a schematic representation of various sensors and electronics in the fuselage, shown in phantom, of an aircraft, according to various embodiments;

FIG. 7 schematically depicts a wireless radio link between multiple airplanes and respective ground-based, internet-connected computing stations, according to various embodiments;

FIG. 8A depicts a first-person viewer (FPV) display showing a variety of telemetry data received from an aircraft in flight, according to various embodiments;

FIG. 8B shows a graphical user interface (GUI) comprising multiple dials, fields, and symbols and including a moving map for presenting telemetry data from an aircraft, according to various embodiments;

FIGS. 9A-9E schematically depict steps involved in assembling the aircraft of FIGS. 1-3, in accordance with various embodiments; and,

FIGS. 10A-10B schematically depict steps involved in charging and hand-launching the aircraft of FIGS. 1-3, in accordance with various embodiments.

### DESCRIPTION OF VARIOUS EMBODIMENTS

Reference will now be made to various embodiments. While the present teachings will be described in conjunction with various embodiments, it will be understood that they are not intended to limit the present teachings to those embodiments. On the contrary, the present teachings are intended to cover various alternatives, modifications, and equivalents, as will be appreciated by those of skill in the art.

Various aspects of the present teachings relate to hand-launched solar-powered aircraft. Additional aspects of the present teachings relate to kits for the construction of hand-launched solar-powered aircraft. Further aspects of the present teachings relate to methods of making hand-launched aircraft. According to various embodiments, the hand-launched aircraft can be solar-powered. Still further aspects of the present teachings relate to educational kits for hand-launched, solar-powered aircraft.

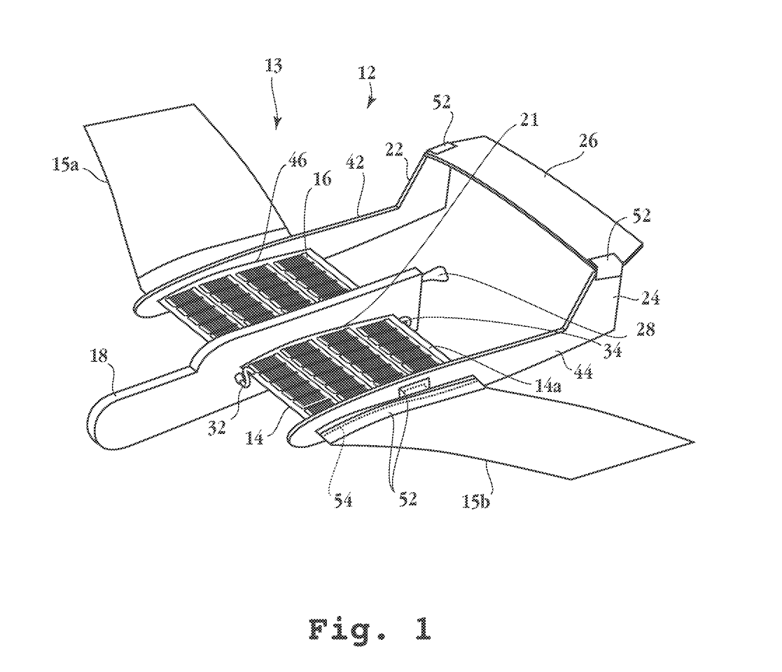

Referring to FIG. 1, in accordance with various embodiments of the present teachings, an aircraft is depicted generally at 12. An elongated airfoil or wing is shown generally at 13, which comprises a main airfoil or wing portion 14, a starboard wing tip 15a, and a port wing tip 15b. Short pieces of tape or stickers (not shown in FIGS. 1-3) underneath stretches of tape or stickers 52 can be employed to fasten the main airfoil or wing portion 14 to each wing tip 15a, 15b. More particularly, one or more stretches of tape or stickers 52 can cover each joint formed between the main wing portion 14 and each of the wing tips 15a, 15b, with the tape or stickers 52 wrapping the wing in a direction from the leading edge to the trailing edge. According to various embodiments, underneath the stretches of tape or stickers, one short piece of tape or a sticker (not shown in FIGS. 1-3) is placed on an upper surface of the wing at the approximate center, bridging the main wing portion 14 and each wing tip 15a, 15b, and similarly, two such short pieces of tape or stickers are placed on an underside of the wing, with one near the leading edge of the wing and one near the trailing edge of the wing, also bridging the main wing portion 14 and each wing tip 15a, 15b.

In various embodiments, main wing portion 14 can comprise a generally arcuate or cambered shape when viewed in vertical cross section (not shown). For example, according to various embodiments, main wing portion 14 can comprise a cambered top and an under-cambered bottom. A solar panel 16 can be fixed on an upper surface of the main wing portion 14. A fuselage is denoted by 18, which comprises a slit 21 for receiving and supporting the main wing portion 14. Slit 21, according to various embodiments, can be generally horizontal in orientation and generally arcuate or cambered in shape, much like the shape of main wing portion 14. Wing tips 15a, 15b can also comprise a generally arcuate or cambered shape when viewed in vertical cross section (not shown). For example, according to various embodiments, wing tips 15a, 15b can comprise a cambered top and an under-cambered bottom. In various embodiments, the camber of the wing tips 15a, 15b is most pronounced closest the main wing portion 14, where it substantially matches the camber of the main wing portion 14. In some embodiments, the camber of the wing tips 15a, 15b gradually decreases in a direction away from the main wing portion 14.

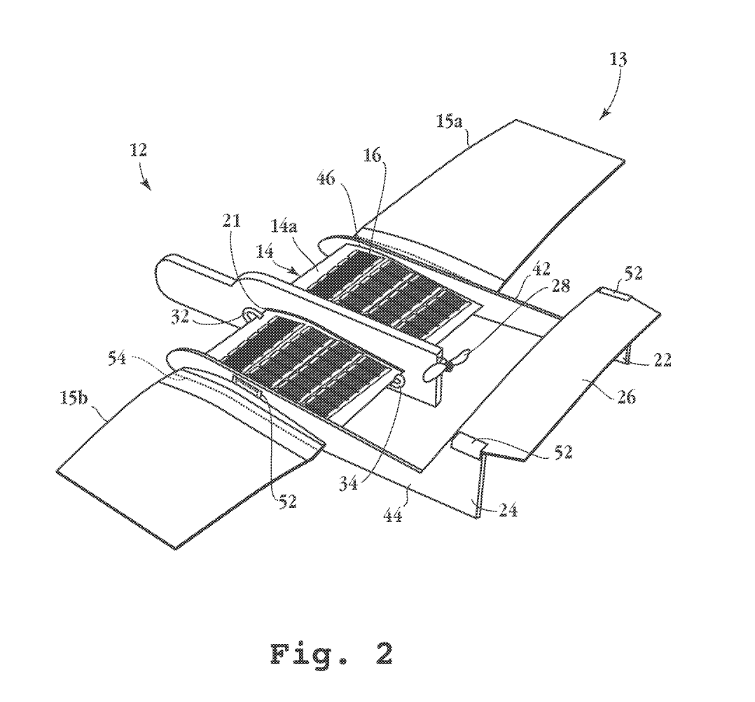

Vertical stabilizers 22, 24 and a horizontal stabilizer 26 are disposed rearward of the fuselage 18. A motor-driven propeller 28 is disposed at the rearward end of the fuselage 18. The motor-driven propeller 28 can comprise, for example, a pusher propeller. One or more energy-storage units (not shown in FIGS. 1-3), such as a super-capacitor, battery, fuel cell, or the like, is supported by the fuselage 18, e.g., towards the front thereof. Means are provided for electrically communicating the solar panel 16 and the energy-storage unit(s). Such means can comprise, for example, plural electrical lines, such as wires 32, 34 and connectors 36, 38 (FIG. 3). Circuitry (not shown in FIGS. 1-3) supported by the fuselage 18 connects the energy-storage unit(s) with the motor-driven propeller 28. A finger-operable switch 41 (FIG. 3) is accessible from one side of the fuselage 18.

Further regarding the means for electrically communicating the solar panel 16 and the energy-storage unit(s) (not shown in FIGS. 1-3), in accordance with various embodiments, first and second lead wires 32, 34 extend from opposing sides of the solar panel 16. First and second lead-wire connectors 36, 38 (FIG. 3), disposed on one side of the fuselage 18, are adapted to receive respective end portions of the first and second lead wires 32, 34. First and second electrical lines (not shown in FIGS. 1-3), supported by the fuselage 18, electrically communicate the first and second lead-wire connectors 36, 38 with the energy-storage unit(s) (not shown in FIGS. 1-3).

In various embodiments, and as depicted in FIGS. 1-3, a vertical stabilizer 22, 24 is provided at the rearward end of each of two booms 42, 44. Forward of each vertical stabilizer 22, 24, a slit 46 (one of which is visible in boom 42 in each of FIGS. 1-2) is provided in each boom 42, 44 for receiving a respective edge region of the main wing portion 14. The slit 46, according to various embodiments, can be generally horizontal in orientation and generally arcuate or cambered in shape, much like slit 21 of the fuselage 18. The horizontal stabilizer 26, in various embodiments, bridges the two vertical stabilizers 22, 24. In this configuration, the vertical stabilizers 22, 24 are spaced apart and generally parallel to one another. According to various embodiments, the attachment of the horizontal stabilizer 26 to the vertical stabilizers 22, 24 is made by way of tape pieces or stickers, as at 52. As can be seen, each sticker 52 contacts a top edge portion of the horizontal stabilizer 26 and an outer edge portion of a respective one of the vertical stabilizers 22, 24. In various embodiments, a rudder (not shown in FIGS. 1-3) can be hingedly connected for pivotal motion to respective edge portions of each of the vertical stabilizers 22, 24. An elevator (not shown in FIGS. 1-3) can be hingedly connected for pivotal motion to an edge portion of the horizontal stabilizer 26. These hinged connections can be made, for example, using stickers or tape pieces like or similar to stickers 52.

In various embodiments, the main airfoil or wing portion 14 includes an upper surface 14a (FIGS. 1-2), a lower surface 14b (FIG. 3), and a plurality of slits extending from the upper surface 14a to the lower surface 14b and generally parallel to the wing chord or camber line, represented by joint 54, such as slit 58 visible in FIG. 3. A plurality of tabs, such as tab 62 in the exploded portion of FIG. 3, are dimensioned to fit snugly in the slits of the main wing portion, such as slit 58, in a direction substantially normal to the upper and lower surfaces of the main wing portion, 14a and 14b. As can be seen in FIGS. 1-3, once the tabs are positioned in their respective slits, a sticker or tape piece 52 can cover the exposed portion of a respective tab and extend onto nearby portions of the aircraft 12, such as the fuselage 18 or one of the booms 42, 44. In this regard, each tape piece 52 can be dimensioned so that it will overhang or extend beyond the edges of its respective tab 62. In various embodiments, the entire tab-facing side of each piece of tape can comprise an adhesive. In this way, various components of the aircraft 12 can be fixed in position and fastened together.

In various embodiments, aspects of the present teachings provide means for preventing propeller strikes. It will be appreciated by those skilled in the art that various embodiments of the aircraft 12, such as depicted in FIG. 1 and FIG. 2, provide protection for the pusher propeller 28 against the undesirable striking of objects, such as the ground or other objects. For example, when the aircraft 12 is sitting on the ground, the propeller 28 is elevated above the ground by the fuselage 18, and is protected on the left and right by the booms 42, 44. The propeller is protected from above by the vertical stabilizers 22, 24 and the horizontal stabilizer 26. Should the aircraft 12 be inverted on the ground, the vertical stabilizers 22, 24 and the horizontal stabilizer 26 will elevate the propeller 28 above the ground, and it will be protected on the left and right by the booms 42, 44. As well, the booms 42, 44 and the fuselage 18 will protect the propeller from above. In sum, the propeller 28 is essentially “boxed,” “sheltered,” or “guarded” by the structure around it. In other words, the structure about the propeller forms a sort of cage that prevents it from striking objects.

According to various embodiments, the components of the aircraft 12 can comprise a relatively durable, lightweight material; e.g., a lightweight foam, plastic, or wooden material. In various embodiments, for example, the aircraft is comprised of an expanded polystyrene material, such as DEPRON foam. For example, one or more of the fuselage 18, wing 13, booms 42, 44, vertical stabilizers 22, 24, and/or horizontal stabilizer 26 can comprise DEPRON®. In some embodiments, carbon reinforcements can be employed on high stress points. For example, wing spar, elevator spar, and/or fuselage spar can be employed. A glue, such as an epoxy, can be used to affix such spars. According to some embodiments, the aircraft can be comprised of an expanded polypropylene foam, or EPP foam.

For example, one or more of the fuselage 18, wing 13, booms 42, 44, vertical stabilizers 22, 24, and/or horizontal stabilizer 26 can comprise EPP. In various embodiments, the aircraft can comprise a combination of DEPRON® and EPP foams. In some embodiments, for example, the aircraft is comprised of a lightweight wooden material, such as balsa wood or basswood.

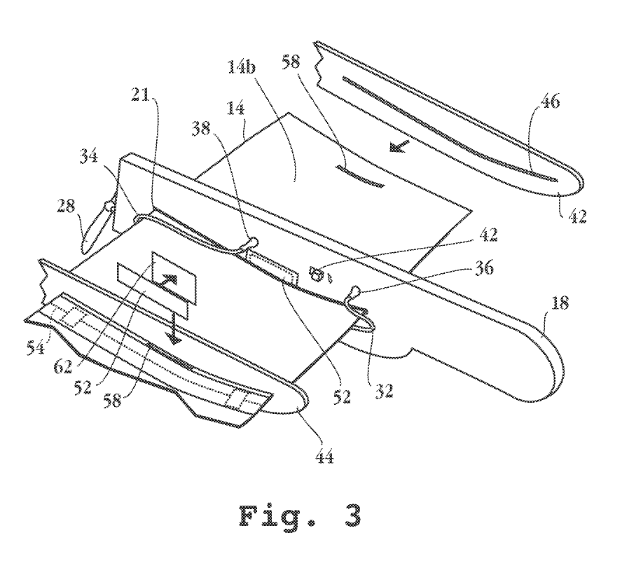

Referring now to FIG. 4, a circuit diagram is provided showing aspects of the electronics for the aircraft 12, in accordance with various embodiments. Toward the left in FIG. 4, the diagonal arrows, at 70, represent sunlight radiating in the direction of the arrowheads. A solar cell is provided at 72, which can comprise, for example, a POWERFILM® MPT4.8-150 Solar Cell. As depicted, the solar cell is disposed so that the sunlight impinges it. On the positive side of the solar cell, a reverse-blocking diode is provided at 74. For example, in various embodiments, the diode can comprise an IN4148. The positive and negative leads from the solar cell connect to a super-capacitor, shown at 76. In various embodiments, the super-capacitor can comprise, for example, a 6F, 2.7 volt super-capacitor. Leads from the super-capacitor connect with a motor, depicted at 78. For example, in various embodiments, the motor can comprise a 3.7 volt 6 mm motor. A switch can be provided between the super-capacitor 76 and the motor 78, such as switch 82 in FIG. 4. In various embodiments, switch 82 can be hand-operable, and in some embodiments, operable by a single finger.

According to various embodiments, and with additional reference to FIGS. 1-2, solar panel 16 is provided on the main wing portion 14, extending on each side of the fuselage 18 of the aircraft 12, and upon exposing it to sunlight 70, the super-capacitor 76 is charged, e.g., within about 90 seconds in full sunlight 70. The charged super-capacitor 76 can then drive the motor 78, e.g., for about 30 seconds without any sunlight when the switch 82 is in the closed position. When in direct sunlight 70, the run time is extended to a continuous state as long as the switch 82 is closed and the solar panel 16 is oriented so it faces the sun.

According to various embodiments, the super-capacitor in the previous embodiments can be replaced or supplemented with a rechargeable battery (not shown), such as one or more NiMH cells. When sunlight is present, it can be advantageous, according to various embodiments, to continuously “trickle charge” up the battery. According to some embodiments, the super-capacitor in the previous embodiments can be replaced or supplemented with one or more fuel cells (not shown), such as one or more micro fuel cells.

It is contemplated herein, according to various embodiments that aircraft according to the present teachings can fly in free flight without external control from the ground; e.g., such aircraft can glide freely, or employ programmable means (e.g., programmable servos) for flight direction. In various embodiments, aircraft of the present teachings can utilize control lines, or they can employ remote radio control.

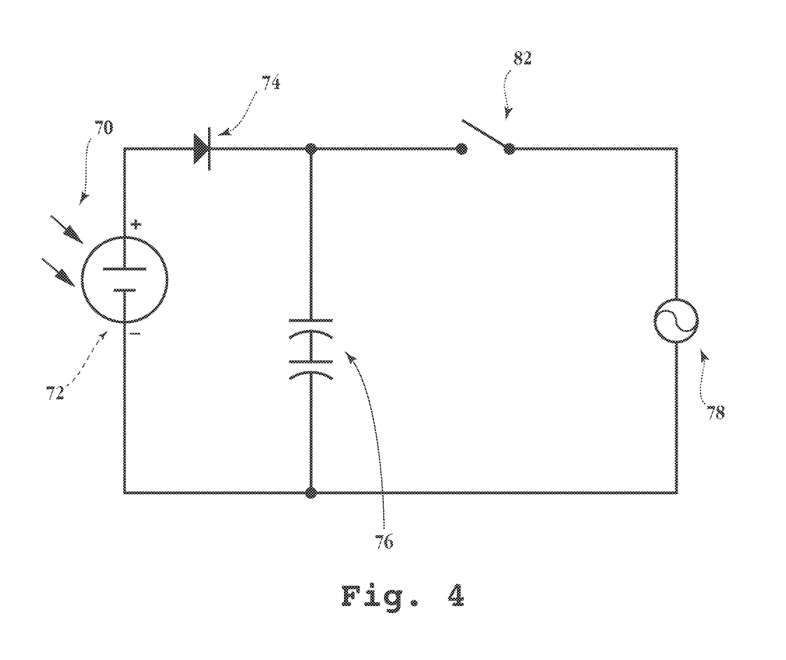

Regarding forms of control, according to various embodiments and referring now to FIG. 5, one or more servos, such as at 96, 97 can be supported by the control surfaces, such as the vertical stabilizer 22, 24 and the horizontal stabilizer 26. A rudder 98 can be hingedly connected to each vertical stabilizer 22, 24 by way of a sticker 52. An elevator 101 can be hingedly connected to the horizontal stabilizer 26 by way of a sticker 52. A first mechanical linkage 99 can operably connect each servo 97 for each rudder 98 such that the servo 97, upon actuation, can cause the rudder to pivot side-to-side; and, a second mechanical linkage 100 can operably connect the servo 96 for the elevator 26 such that the servo 96, upon actuation, can cause the elevator 101 to pivot up and down. Electrical lead lines 103 running along a boom 22 and the horizontal stabilizer 26 can provide power from the power storage unit(s) (not shown in FIG. 5) to the servos 96, 97. A small ribbon cable/connector (not visible in FIG. 5) can provide a connection for the electrical lead lines at the junction of the boom 22 and the horizontal stabilizer 26.

According to various embodiments, remote-control means are provided for controlling the movement of the servos. In a variety of embodiments, the remote-control means comprises a remote control receiver supported by the fuselage and adapted for communication with the servos. In various embodiments, a radio controller (not shown) is provided that can bind with the remote control receiver. The controller can be, for example, battery powered and/or solar powered. In some embodiments, the controller comprises a computing device (e.g., a smartphone, tablet, laptop or desktop computing apparatus). In some embodiments, remote control means comprises a control line (not shown).

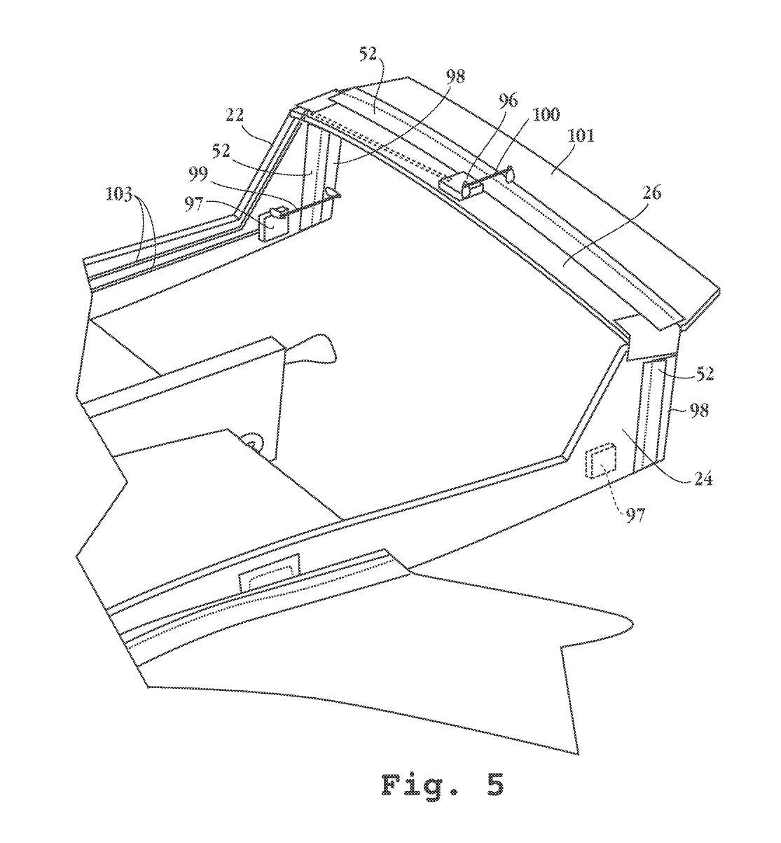

In various embodiments, and referring now to FIG. 6, the aircraft can further comprise a PCB board 109 comprising a processing unit 111, and one or more sensors, as at 102, 105 and 107, in communication therewith and adapted to collect flight-related information and/or environmental information. In some embodiments, the sensors 102, 105, 107 comprise one or more of: a camera, a power meter, a volt meter, a timer, an altimeter, an airspeed micro-sensor, a GPS (global positioning system unit), a thermometer, a hygrometer, a barometer, a compass, an accelerometer, a gyroscope, a magnetometer, a luxmeter, a microphone, a proximity sensor, a bank sensor, and an attitude sensor. In various embodiments, a chronometer (not shown) is provided on the PCB board 109. According to various embodiments, the flight-related information and/or environmental data for collection includes one or more of: solar power generation data, power consumption data, voltage data, RPM data, signal strength data, flight time data, image capture data, temperature data, barometric altitude data, humidity data, light intensity data, air pressure data, wind data, bank data, attitude data, G-force data, and time data; and GPS data including ground speed data, airspeed data, altitude data, latitude data, longitude data, rate of climb data, distance data, and directional (compass) data including heading data.

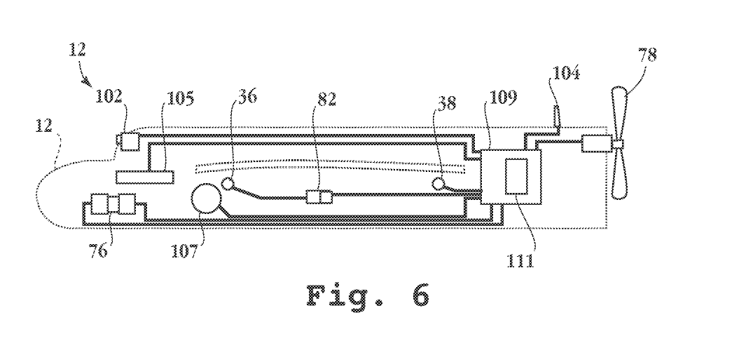

According to various embodiments, and with primary reference to FIGS. 6 and 7, sensor 102 (FIG. 6) comprises a camera, such as a digital camera, which is mounted on the fuselage 18 of the aircraft 12. In some embodiments, the camera 102 is adapted to collect video and/or pictures, either continuously or periodically, during flight. In some embodiments, the camera 102 takes sequential video and/or pictures automatically at desired intervals. In other embodiments, a user can turn video and/or photo capture on and off from the ground using a radio transceiver (not shown). In various embodiments, the video and/or pictures can be stored in a memory for subsequent retrieval. In some embodiments, the storage comprises a memory card (not shown), such as a MICRO SD (secure digital) memory card. In various embodiments, a wireless video down-link is provided so that video and/or pictures can be off-loaded from the camera 102 and sent via a radio transmitter, as indicated at 104, wirelessly to a receiver, such as a ground-based receiver 94 (FIG. 7) comprising a memory or attached to an apparatus, such as a computing apparatus 92, comprising a memory for storing the video and/or pictures. The video and/or pictures can be viewed on a display 95, as desired.

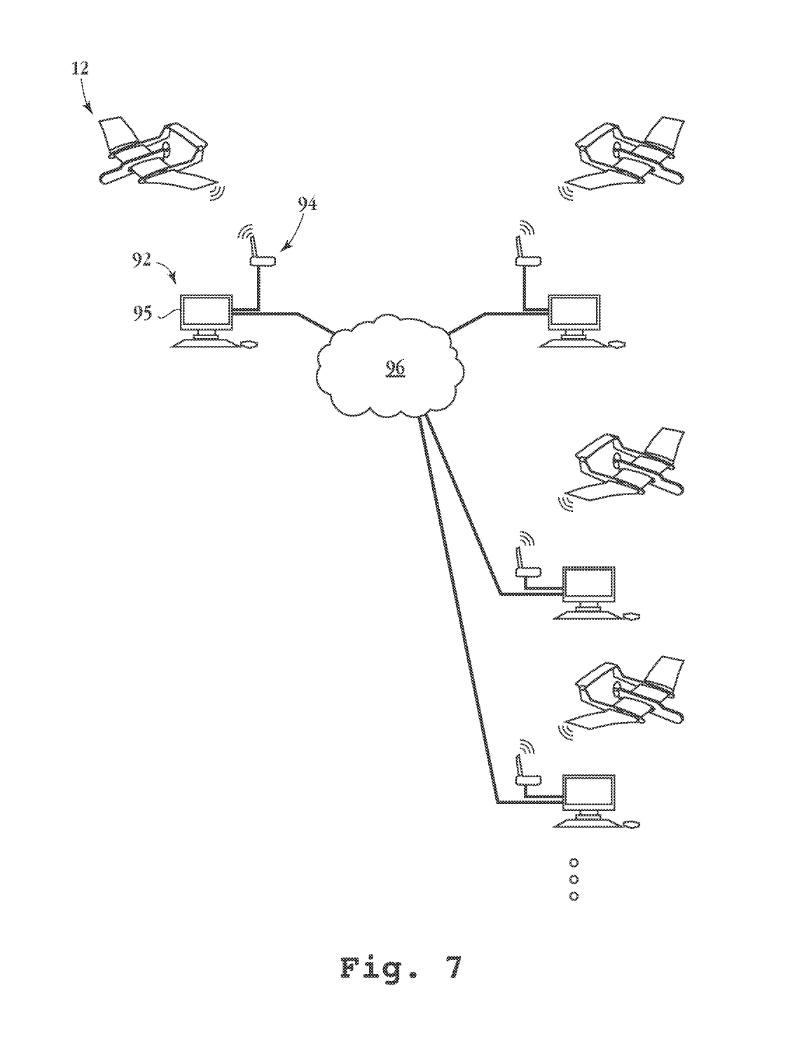

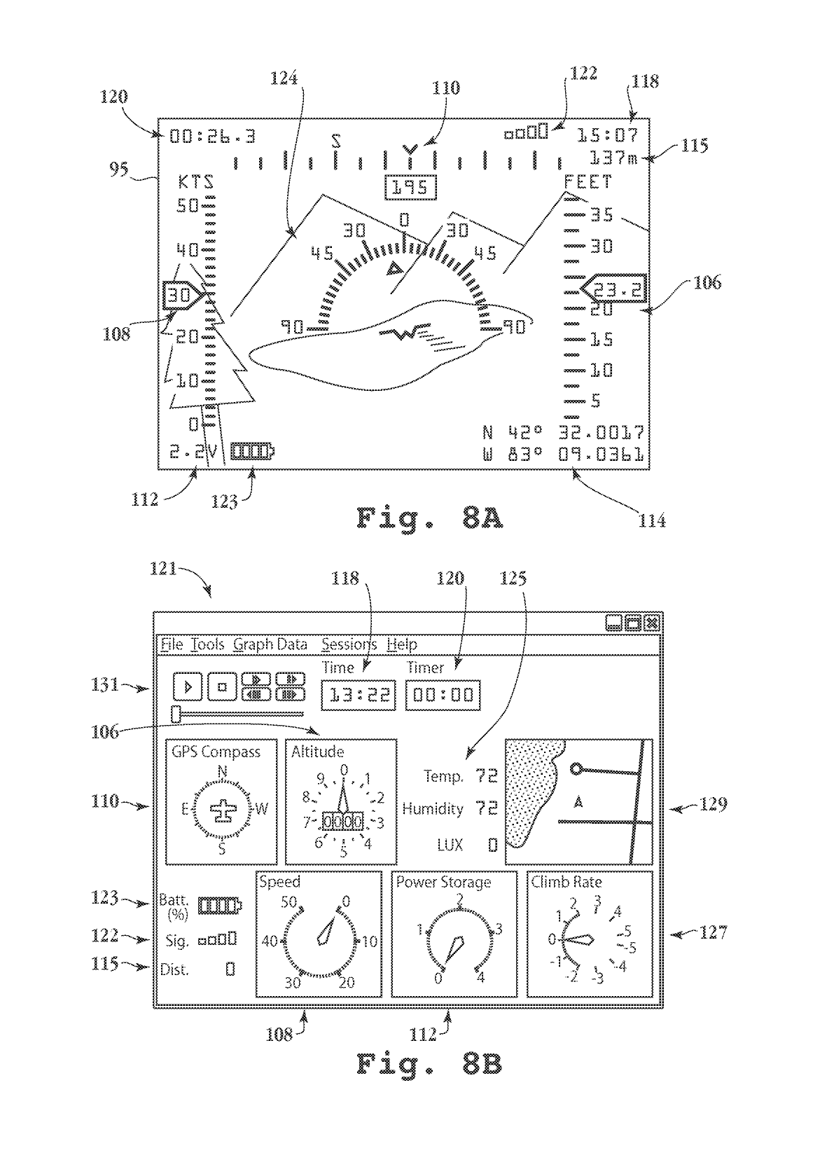

According to various embodiments, and with additional reference to FIG. 8A, a first-person-view (FPV) system can comprise camera 102, transmitter 104, receiver 94, and display 95. Various embodiments comprise additional hardware, including, for example, on-screen displays with GPS navigation (not shown), flight data, environmental data, stabilization systems (not shown), and autopilot devices with optional “return to home” capability (not shown)—allowing the aircraft 12 to fly back to its starting point on its own in the event of signal loss. In some embodiments, one or more on-board cameras 102 can be equipped with a pan and tilt mount (not shown), which when coupled with video goggles and “head tracking” devices (not shown), for example, can create an immersive, first-person experience, as if the viewer was actually sitting in the cockpit of the aircraft 12.

In various embodiments, and with continuing reference to FIG. 8A, a video overlay module can overlay flight telemetry information onto a video image shown on a display 95. The telemetry information displayed can include, for example, flight altitude 106, flight speed 108, flight direction 110, voltage 112, latitude/longitude 114, distance from home 115, time of day 118, flight time 120, signal strength 122, power consumed 123, bank and attitude information 124, among other information.

Referring next to FIG. 8B, much of the same information is displayed as in FIG. 8A, however, in a graphical user interface (GUI) comprising a dashboard 121. Additionally, the dashboard 121 of FIG. 8B shows environmental data 125, rate-of-climb data 127, and moving map data 129. Further, the dashboard 121 provides software controls 131 that permit recording, playback, and searching of the various data.

It will be appreciated by those skilled in the art that the data and features shown in FIGS. 8A-8B are exemplary and provided for the purposes of description, and that other data and features can be provided in addition to, or instead of, the depicted data and features.

In some embodiments, telemetry information is off-loaded from the aircraft substantially in real-time during flight by way of a radio transceiver, such as a Wi-Fi radio (e.g., a RN-XV WiFly module by Roving Networks), and received by another Wi-Fi radio, such as a ground-based smartphone, tablet, laptop, desktop, or other Wi-Fi enabled computing apparatus, or Wi-Fi-equipped radio controller. The off-loaded telemetry information can then be saved on any suitable memory device; e.g., memory card, such as a MICRO SD (secure digital) card, thumb drive, disc drive, CD/DVD, etc. The saved telemetry information can, for example, be played back via software for such purpose, as desired.

Further aspects of the present teachings relate to educational kits for hand-launched, solar-powered aircraft. According to various embodiments, such a kit can comprise:
a. a plurality of solar-powered aircraft component parts, comprising:
   i. a wing;
   ii. a solar panel for attachment to the wing;
   iii. a fuselage for supporting the wing;
   iv. a vertical stabilizer and a horizontal stabilizer, optionally including a rudder and an elevator, respectively;
   v. a motor-driven propeller, such as a pusher propeller;
   vi. one or more power-storage units, e.g., a super-capacitor, supported by the fuselage;
   vii. a plurality of electrical lines, e.g., wires, for connecting the solar panel and the power-storage units;
   viii. circuitry for connecting the power-storage units with the motor-driven propeller; and,
   ix. a switch, e.g., a finger-operable switch, in the circuitry;
b. instructions for assembling and operating said aircraft; and,
c. educational material on one or more science and technology learning topics, which educational material is relevant to and supplemented by the assembly or operation of the aircraft.

In various embodiments, the educational material relates to flying techniques, aeronautics, renewable energy, electronics, and/or mechanical engineering. In some embodiments, the educational material relates to renewable energy, electronics, and/or mechanical engineering.

According to various embodiments, one or more of the solar-powered aircraft component parts are preassembled in the kit. For example, the motor-driven propeller can be mounted onto the fuselage and appropriately wired in advance of being packaged into the kit container for shipment. In addition, for example, the power-storage unit(s) (e.g., one or more super-capacitor(s) can be mounted in the fuselage, and appropriate electrical connections internal to the fuselage made in advance of packaging. In other embodiments, all or some of the electronics can be provided as component parts and assembled by the end user.

In various embodiments, the instructions are provided in hard copy format. In a variety of embodiments, the instructions are provided online, and a pointer (e.g., a hyperlink or url) to the instructions is provided in the kit. In some embodiments, a memory device (e.g., a CD, DVD, memory care, thumb drive, or the like) is provided in the kit, and the instructions are provided in electronic format (e.g., PDF) on the memory device.

In various embodiments, the educational materials are provided in hard copy format. In a variety of embodiments, the educational materials are provided online, and a pointer (e.g., a hyperlink or url) to the educational materials is provided in the kit. In some embodiments, a memory device (e.g., a CD, DVD, memory care, thumb drive, or the like) is provided in the kit, and the educational materials are provided in electronic format (e.g., PDF) on the memory device. The educational materials can be, for example, no greater than elementary school level, no greater than middle school level, no greater than high school level, no greater than college level, and/or graduate school level, as desired.

In various embodiments, a teacher's or instructor's edition kit can comprise, in addition to the foregoing, a teacher's manual or resource guide, which can be in hard copy, electronic, or pointer (e.g., url or hyperlink) format. According to various embodiments, the teacher's manual can describe various uses of kits in accordance with the present teachings in a classroom or multi-classroom format. The manual can include, for example, various learning activities that students can engage in to supplement or reinforce the educational aspects of the kits. The learning activities can be individual activities and/or group activities. The manual can further include template forms, for example, that students can use to record their observations when carrying out hands-on learning and/or experiential learning projects with their kits, including both the building of the aircraft and use of the finished aircraft. The manual can describe, for example, exemplary projects to assign to students, each having a one or more specific learning objectives. Additionally, among other things, the manual can provide lesson plans and various quizzes or tests, with exemplary answer keys, that a teacher can use in connection with employing the kits of the present teachings as a teaching tool.

In various embodiments, and referring now primarily to FIG. 7, each of a plurality of separate classrooms, which can be geographically dispersed, each equipped with or having access to a web-enabled computing apparatus, such as at 92, can be provided with one or more educational kits of the present teachings. Each class can be instructed to assemble, e.g., as a group project, an aircraft 12 of the present teachings using their kit(s). Optionally, the classroom teacher can conduct lessons on one or more science and technology learning topics, which topics are relevant to and supplemented by the assembly and/or operation of the aircraft 12. The class can then take the assembled aircraft 12 outdoors to fly it. Upon flying the aircraft 12, sensors disposed on the aircraft 12 can collect selected flight- and/or environmental-related data. The data can be retrieved at the end of the flight, or, as depicted in FIG. 7, it can be received via a wireless radio transceiver 94, such as a Wi-Fi radio, substantially in real-time from a wireless radio transceiver (not shown in FIG. 7) mounted on the aircraft 12, such as a Wi-Fi radio, during flight and stored in a memory device, such as in a memory of computing apparatus 92. The data can then be uploaded to cloud storage on the internet, represented at 96. In a variety of embodiments, the uploaded data is stored in one or more databases (not shown) in the cloud. According to various embodiments, the cloud storage can comprise a part of, or be accessible to, a web portal (not shown) where the various classrooms can access their respective uploaded data via their web-enabled computing apparatus 92 and, optionally, manipulate their data using various software tools and apps provided by the portal. In various embodiments, the classrooms can conduct repeated flights and data uploads, and view their data over time (e.g., sets of flight data collected under a variety of environmental conditions). They can perform trend analysis, extract information, and do other tasks, using their uploaded data. To assist in these efforts, they can make use of the various software tools and apps provided by the portal. According to a variety of embodiments, the portal permits the various classrooms to open access to their data, in full or part, to one another for data sharing. In this way, the various classrooms can utilize one another's data in their analyses, or simply view the trends, information, and such, identified by other classrooms, and, for example, compare and contrast them to their own. In various embodiments, the portal can also comprise social networking features to aid in learning and encourage discourse, such as personal workspace features, classroom workspace features, interest groups features, discussion/commenting features, liking/rating features, statistics features, timeline features, announcements features, news features, and such.

In various embodiments, an educational kit of the present teachings includes a pointer, such as a link or url, and a password to access a web portal, substantially as described above, that is accessible to individuals in the general population from substantially any web-enabled computing apparatus (i.e., not necessarily in a classroom setting). Here, general novices, enthusiasts, hobbyists, and such, can take part in the educational and social learning aspects provided by the present teachings.

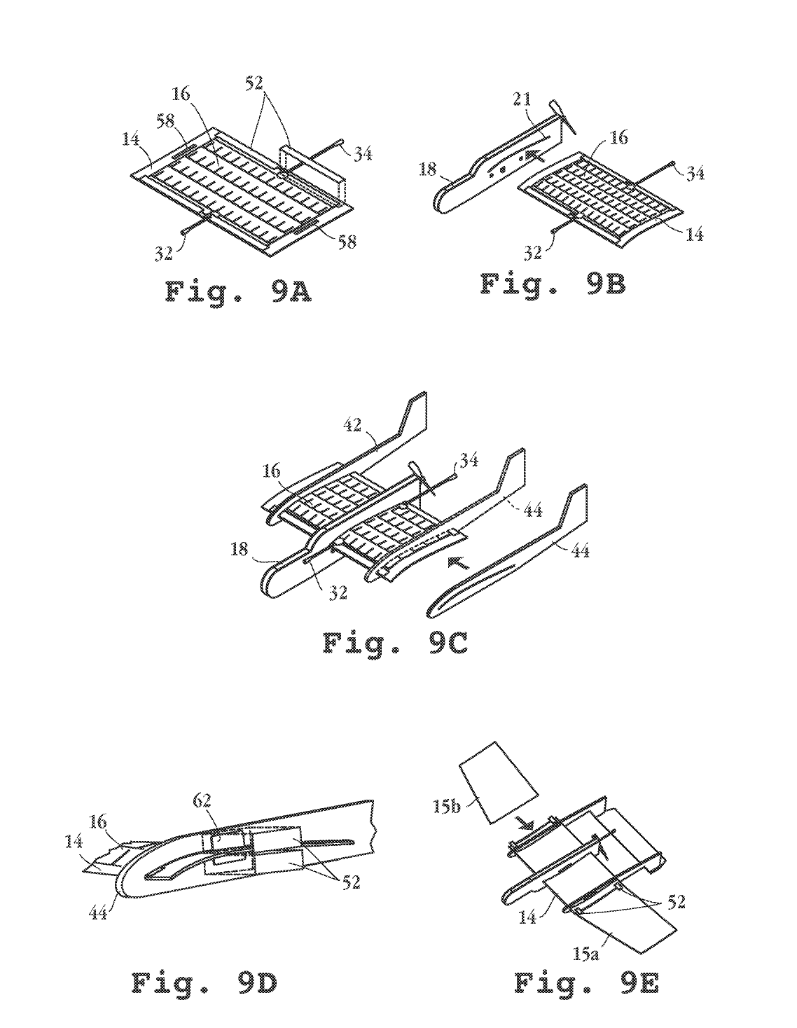

Next, with primary reference to FIG. 9A-FIG. 9E, an exemplary embodiment of making the aircraft will be described.

Initially, with primary reference to FIG. 9A, the solar panel 16 is attached to the top of the main wing panel 14. The solar panel 16 is centered between the slits 58 near the outer edges of the main wing panel 14. Four stickers 52 are employed to attach the solar panel 16 to the main wing panel 14. The stickers 52 extend beyond the ends of the solar panel 16, for example, by about ⅛ of an inch.

Next, with primary reference to FIG. 9B, the main wing panel 14 is slid into the slit 21 in the fuselage. The side of the main wing panel 14 is used that is further away from the wires 32, 34 attached to the solar panel 16. Then, the main wing panel 14 is turned over (not shown) and the fuselage 18 centered on the main wing panel 14 so the center wing slits 58 are even with the lateral edges of the fuselage 18. The main wing panel 14 should be at the rear edge of the slit 21.

Next, referring back to FIG. 3, one tab 62 is slid into each of the slits 58 in the center of the main wing panel 14. Each tab 62 should be tight against the fuselage 18. A sticker 52 is placed over each of the tabs 62 to secure them to the sides of the fuselage 18.

Then, with primary reference to FIG. 9C, the tail booms 42, 44 are slid on to the main wing panel 14. They can be moved, for example, about ¼ of an inch past the ends of the solar panel 16.

Next, with primary reference to FIG. 9D, one tab 62 is slid into a slit 58 near one end of the main wing panel 14. The tail boom 42 is slid over so it is touching the tab 62. The tail boom 42 should be aligned with the edge of the solar panel 16. A sticker 52 is then placed on the part of the tab 62 that is above the main wing panel 14. A sticker 52 is also placed on the part of the tab 62 that is below the main wing panel 14. The foregoing process is then repeated for the other tail boom 44.

Next, with primary reference to FIG. 1, stickers 52 are placed on the top of the horizontal stabilizer 26. Then, the horizontal stabilizer 26 is placed on top of the vertical stabilizers 22, 24 and the stickers 52 bent down so they are attached to the top of each vertical stabilizer 22, 24.

Then, with primary reference to FIG. 9E, two stickers 52 are attached to the bottom of the main wing panel 14 at each tip end, with one at the forward edge and one at the rearward edge. Next, the wing tips 15a, 15b are attached to the main wing panel 14. The wing tips 15a, 15b have a slight curve. The curve of each wing tip 15a, 15b should be matched to the curve of the main wing panel 14.

Next, each wing tip 15a, 15b is bent up (not shown) so the gap is closed. Another sticker 52 is used to hold each of the wing tips 15a, 15b in place. Next, a sticker 52 is placed along the top and bottom of each wing tip 15a, 15b to main wing panel joint. The stickers 52 should be centered over the joint.

Next, referring primarily to FIGS. 2-3, the solar panel 16 is connected to the fuselage 18. This is done by connecting end portions of the first and second lead wires 32, 34 extending from opposing sides of the solar panel 16 to the first and second lead-wire connectors 36, 38, respectively, disposed on one side of the fuselage 18. Once connected, the switch should be in the “Store” position. The aircraft can then be placed under a light or in sunlight for several minutes. After charging, the motor will then start running when the switch is moved to the “Run” position. When maintained in bright sunlight, the motor should run continuously when the switch is in the “Run” position.

Now, aspects of flying an aircraft in accordance with various embodiments of the present teachings will be described.

Before flying the aircraft under power, it can sometimes be desirable to give it a few hand glides. This can assist in the determination of which direction the aircraft will tend to turn, if any. It will also assist in the determination of any minor adjustments that are needed in the horizontal stabilizer, if any. According to various embodiments, the hand glides are carried out in calm wind conditions. This can help to make sure any observations are a result of the way the aircraft tends to fly, and are not a function of wind or wind gusts.

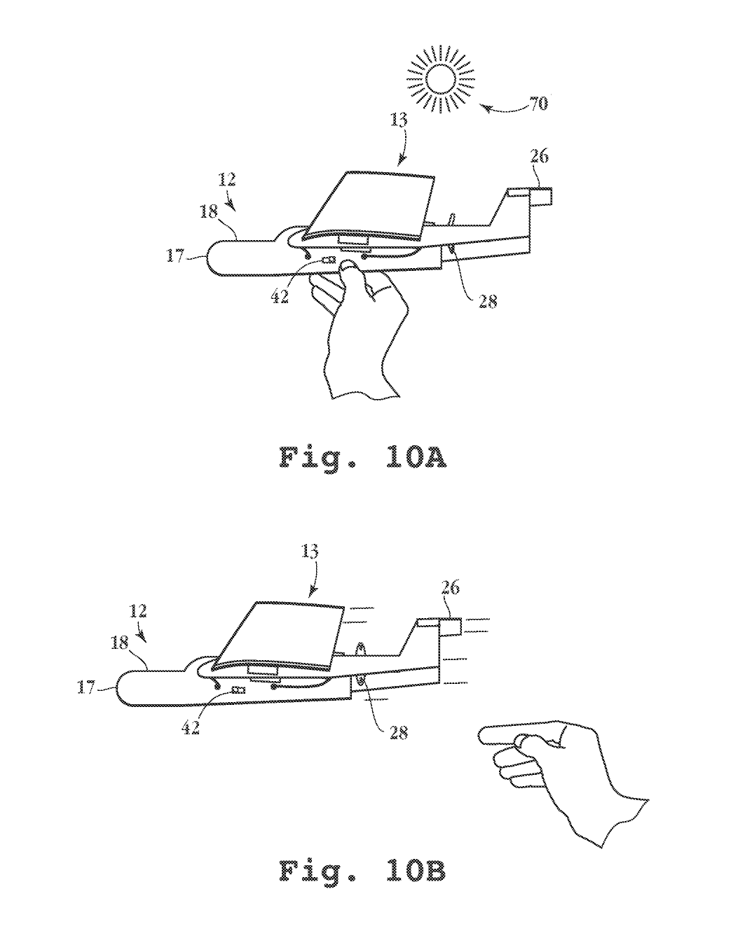

According to various embodiments, when hand gliding the aircraft, it can be advantageous to use gentle arm movements. With reference now to FIG. 10A-FIG. 10B, the aircraft 12 is gripped under the fuselage 18 approximately in the middle. The arm is moved forward in a manner as if throwing a dart, and the nose 17 of the aircraft 12 is pointed down very slightly. The aircraft 12 is released upon the arm reaching just about all the way forward.

Upon releasing the aircraft 12 for flight, according to various embodiments, the flight path should be observed. The aircraft 12 should turn on its own, to the left or right. The direction does not matter. Some turn can be beneficial to keep the aircraft 12 from flying too far away when power is applied. Also, it should be noted whether or not the aircraft 12 flies with a gradual decent path. If the glide path of the aircraft 12 has dips, it may be stalling. In this event, it can be advisable to check to make sure the wing 13 is all the way back in the slit 21 of the fuselage 18. If it is not, it may be desirable to carefully move the wing 13 back. If the wing 13 is all the way back, it may be desirable to add a small amount of modeling clay (not shown) or the like for added weight to the nose 17. If the glide path of the aircraft 12 is too steep, it may be desirable to bend the rear of the horizontal stabilizer 26 up a slight amount. It should be noted that it does not take much of a bend to affect the glide path. Once satisfied with the results of the hand glides, the aircraft 12 is ready for powered flight.

For the aircraft's maiden powered flights, according to various embodiments, it may be desirable to select a day with fairly calm winds. Once it has been confirmed that the aircraft 12 is flying with the desired flight path, it can then be flown with some wind present. In various embodiments, it may be desirable to avoid flying it in strong winds, as in strong winds it can travel a considerable distance and may land in a place that could make it difficult to retrieve. Of course, in very large areas generally free of obstacles such as trees or buildings, or other potential hazards, this may not be a concern.

According to various embodiments, in bright sunlight 70 the aircraft can take several minutes to fill the energy-storage unit (not shown). With the switch 42 in the “Store” position, the aircraft 12 can be held so the solar panel (not visible in FIGS. 10A-B) is receiving direct sunlight 70. After about 3 minutes, the aircraft 12 can then be held so it is facing into any prevailing wind. At this point, the switch 42 can be moved to the “Run” position. Using the same launching technique as when performing the hand glides, the aircraft 12 can then be launched. In various embodiments, the nose 17 should be level. Care should be taken to avoid launching the aircraft 12 with the nose 17 pointed up.

According to various embodiments, it can be expected that the aircraft 12 might climb out of one's hand turning in the direction noted during the glide test. It may climb, for example, to a height of 20 to 30 feet, or more (e.g., up to 100 feet) while circling. As the stored energy is consumed, the motor of the motor-driven propeller 28 will slow down and the aircraft 12 will start descending. Often, the motor will continue to run after the aircraft 12 lands. The switch 42 can then be moved to the “Store” position to turn off the motor. Doing this will also start storing energy for the next flight.

All references set forth herein are expressly incorporated by reference in their entireties for all purposes.

Those skilled in the art can now appreciate from the foregoing description that the broad teachings herein can be implemented in a variety of forms. Therefore, while the present teachings have been described in connection with various embodiments and examples, the scope of the present teachings are not intended, and should not be construed to be, limited thereby. Various changes and modifications can be made without departing from the scope of the present teachings.

It is claimed:

1. A hand-launched solar-powered aircraft, comprising:
an elongated wing, including a main wing portion;
a solar panel on an upper surface of said main wing portion;
a fuselage comprising a slit for receiving and supporting said main wing portion;
a vertical stabilizer and a horizontal stabilizer rearward of said fuselage;
a motor-driven propeller at an end of said fuselage;
one or more super-capacitors supported by said fuselage;
means for electrically communicating said solar panel and said super-capacitors;
circuitry connecting said one or more super-capacitors with said motor-driven propeller;
a hand-operable switch in said circuitry accessible from outside said fuselage; and
means for preventing propeller strikes.

2. The aircraft of claim 1, wherein said means for electrically communicating said solar panel and said super-capacitor comprises:
first and second lead wires extending from said solar panel;
first and second lead-wire connectors on said fuselage adapted to receive said first and second lead wires, respectively; and,
first and second electrical lines electrically communicating said first and second lead-wire connectors with said super-capacitor.

3. The aircraft of claim 1, wherein said elongated wing further includes an add-on port wing tip portion and an add-on starboard wing tip portion; with said wing tip portions disposed at respective ends of said main wing portion.

4. The aircraft of claim 3, further comprising a plurality of stickers; wherein said wing tip portions are fastened to the main wing portion by way of said stickers.

5. The aircraft of claim 1, further comprising first and second booms, each comprising a slit towards its forward end for receiving a respective edge region of said main wing portion.

6. The aircraft of claim 5, wherein each of said booms further comprises a vertical stabilizer at its rearward end.

7. The aircraft of claim 6, wherein said horizontal stabilizer bridges said vertical stabilizers.

8. The aircraft of claim 7, further comprising a plurality of stickers; wherein said horizontal stabilizer is fastened to the vertical stabilizers by way of said stickers.

9. The aircraft of claim 5, wherein said main wing portion includes an upper surface, a lower surface, and a plurality of slits extending from said upper surface to said lower surface and generally parallel to the wing chord or camber line; and further comprising a plurality of tabs dimensioned to fit snugly in said slits of said main wing portion, in a direction substantially normal to the upper and lower surfaces of said main wing portion; and, a plurality of stickers for securing said tabs to said fuselage and said booms.

10. The aircraft of claim 1, wherein said propeller comprises a pusher propeller mounted at the rear of said fuselage.

11. The aircraft of claim 1, further comprising one or more sensors on said aircraft adapted to collect flight information, environmental information, or a combination thereof.

12. The aircraft of claim 11, wherein said information includes one or more of solar power generation data, power consumption data, voltage data, RPM data, signal strength data, flight time data, image capture data, temperature data, altitude data, humidity data, light intensity data, air pressure data, wind data, bank data, attitude data, speed data, G-force data, latitude data, longitude data, rate of climb data, distance data, and directional data.

13. A kit for constructing a hand-launched solar-powered aircraft, comprising:
a main wing portion, including an upper surface, a lower surface, and a plurality of slits extending from said upper surface to said lower surface and generally parallel to the wing chord or camber line;
a solar panel for attachment to said upper surface of said main wing portion;
a fuselage, including a slit for receiving and supporting said main wing portion;
a plurality of tabs dimensioned to fit snugly in said slits of said main wing portion, in a direction substantially normal to the upper and lower surfaces of said main wing portion;
a plurality of stickers for fastening components of said aircraft together; and,
instructions for assembling and operating said aircraft.

14. The kit of claim 13, further comprising:
first and second booms, each including a slit towards its forward end for receiving a respective edge portion of said main wing portion, and a vertical stabilizer at its rearward end; and,
first and second wing tip portions for attachment to respective edge regions of said main wing portion to thereby comprise an elongated main wing; and,
wherein said horizontal stabilizer is configured to bridge said vertical stabilizers.

15. The kit of claim 13, further comprising a super-capacitor supported by said fuselage.

16. The kit of claim 15, further comprising:
first and second servos supported by said fuselage;
a rudder hingedly connected to said vertical stabilizer by way of a sticker;
an elevator hingedly connected to said horizontal stabilizer by way of a sticker;
a first mechanical linkage operably connecting said first servo and said rudder such that the servo can cause the rudder to pivot side-to-side; and,
a second mechanical linkage operably connecting said second servo and said elevator such that the servo can cause the elevator to pivot up and down.

17. The kit of claim 16, further comprising programmable means for controlling the movement of said rudder and elevator.

18. The kit of claim 16, further comprising remote-control means for controlling the movement of said servos.

19. A method of making a hand-launched aircraft, comprising:
inserting a main wing portion into a slit of a fuselage to the general midpoint of the main wing portion, such that the main wing portion rests snugly in the slit;
inserting a tab into a slit extending through the main wing portion, substantially normal to the upper and lower surfaces of the main wing portion and adjacent the fuselage, so that at least a portion of the tab, held snugly in the slit, abuts the fuselage; and,
applying a sticker across at least a portion of the tab and onto one or more portions of the fuselage, thereby fixing the spatial relationship between the main wing portion and the fuselage.

20. The method of claim 19, further comprising attaching first and second wing tip portions to respective edge regions of said main wing portion by way of stickers.

21. An educational kit for a hand-launched, solar-powered aircraft, comprising:
(i) a plurality of solar-powered aircraft component parts, comprising:
(a) a wing;
(b) a solar panel for attachment to said wing;
(c) a fuselage for supporting said wing;
(d) a vertical stabilizer and a horizontal stabilizer;
(e) a motor-driven propeller;
(f) one or more power-storage units for storing energy collected by said solar panel and providing energy to said motor-driven propeller;
(g) a plurality of electrical lines for connecting said solar panel with said power-storage units;
(h) circuitry for connecting said power-storage units with said motor-driven propeller; and,
(i) a switch in said circuitry;
(ii) instructions for assembling and operating said aircraft; and,
(iii) educational material on one or more science and technology learning topics, which educational material is relevant to and supplemented by the assembly or operation of said aircraft.

22. The educational kit of claim 21, wherein the educational material relates to one or more of flying techniques, aeronautics, renewable energy, electronics, mechanical engineering, and climatology.

23. The educational kit of claim 21, wherein one or more of the solar-powered aircraft component parts are preassembled.
